(19) United States
(12) Patent Application Publication
(10) Pub. No.: US 2004/0190774 A1
(43) Pub. Date: Sep. 30, 2004

(54) Method for classifying and accessing writing composition examples

(76) Inventor: Daniel P. Baker, Yarmouthport, MA (US)

Correspondence Address: Daniel P. Baker, 20 Richard Road, Yarmouthport, MA, 02675, US

(21) Appl. No.: 10/402,515

(22) Filed: Mar. 28, 2003

(51) Int. Cl. G06F 17/27

(52) U.S. Cl. 382/187

(57) ABSTRACT

A method of classifying and accessing writing examples for writing composition. A language domain is first selected and representatives texts from that domain are analyzed to build a classification system for the domain. The text is first analyzed to determine root nouns and root verbs. The texts are further analyzed to determine relationships between nouns and the root verbs used for each noun-to-noun relationship. At this point, writing examples are then extracted from the texts and stored in a database. These writing examples are then classified by the earlier defined noun-to-noun relationships and root verbs that go along with those noun-to-noun relationships. Access to the writing examples is accomplished via a three-level interface. The first level (noun interface) maps nouns and pre-determined relationships between those nouns. By selecting one of these relationships, a navigation link takes the user is a second level (verb interface) showing root verbs that relate to the particular noun-to-noun relationship selected. Here the user selects a particular root verb which causes a query of the writing examples database. The results of the query are sent to a third level interface (results interface) where the writing examples are displayed. The user may then select one or more writing examples to insert in a word processing program or document where the user may modify them for the writing job at hand.

### CROSS-REFERENCES TO RELATED APPLICATIONS

Not applicable.

### BACKGROUND—FIELD OF INVENTION

This invention relates to writing composition, specifically a method of classifying and accessing writing examples.

### BACKGROUND—DISCUSSION OF PRIOR ART

Writing software has been available since the dawn of the computer age, and its popularity surged when the IBM PC was introduced in 1981.

In fact, writing software has been a hugely successful category within the software industry. And while the current market leader is Microsoft Word, dozens of competing writing software are available for purchase. Many can also be freely downloaded off the Internet.

While today's commercial writing software often includes non-writing functions such as image capture and sound, the writing functions these software perform are in three main categories: word processing, writing critique, and writing composition.

1. Word processing functions manage the job of assembling and modifying text material on the electronic page. Word processing (or text processing) functions would include typing, cutting and pasting of text, and formatting the text. Other functions include merging text with database fields (mail merge), and tracking the edits made by various people collaborating to write or edit the text.

2. The second key function of writing software is writing critique. Writing critique is the process of examining previously composed text to uncover flaws related to bad spelling, incorrect grammar, or weak style. Examples of these functions include: spell checking, grammar checking, and style checking.

Writing critique functions generally look for certain character and word patterns in the text, then compare those to a rules database. Like word processing, writing critique has become an extremely popular feature in today's writing software.

3. Writing composition is the third key function of writing software. The job of writing composition is to help writers choose the best words, phrases, and sentences to convey the meaning they want to communicate to the reader.

However, at this time, the range of writing composition functions in writing software is relatively limited. In fact, the only popular writing composition function today is the electronic thesaurus.

An electronic thesaurus helps writers find the synonyms or antonyms of a individual word or short phrase. But if the writer wants the synonym of a complete sentence or a subject-verb-object thought, a thesaurus will not help. Yet, such a sentence thesaurus or “sentaurus” would be immensely helpful to writers. It would enable a writer to access entire sentences or groups of sentences that convey a certain meaning. And the ability to efficiently access writing examples composed by professional writers would make the task of writing much easier for huge population of part-time or occasional writers.

The lack of such commercially available writing composition software is somewhat surprising when you consider the millions of writers who toil over their writing work. High school students struggle to write their history essays. Business people rack their brains to persuade others in their correspondence. And novelists and comedians scratch their heads to write their creative works.

Of course, the chief reason writers struggle is that writing is akin to “thinking”—what Emerson has called the “hardest task in the world.” (Intellect from Essays: First Series, 1841)

Yet ironically, thanks to the Internet, good writing examples have never been more accessible. Many popular consumer and business magazines archive several years worth of well-written, scrupulously-edited articles on-line. There are also plenty of fine writing examples in the public domain at libraries and on-line. Many of these writing examples can be downloaded free from government websites. There are also web sites that feature the copyright-expired works of 19^{th} century or earlier writers, such as Mark Twain.

So it appears that advancements in the prior art of writing composition software have not kept pace with demand and the growing availability of source material.

One major stumbling block for writing composition software publishers has been the sheer complexity of human language. It's tough to classify language text and narrow down the magnitude of writing variations and sentence structures to a manageable indexing scheme.

For this reason, it is generally impractical to construct a language model that covers an entire spoken language. There are just too many subject areas to cover, so any classification system devised becomes complex and cumbersome to work with.

The User Interface

Another factor slowing the emergence of writing composition software is the user interface. In general, the prior art's user interfaces and methods are inefficient for accessing writing examples.

In designing the interface to writing composition examples, the publisher has four types of user interface to choose from: keyword, tree hierarchy, map, and dynamic interfaces.

Keyword Interface—In a keyword interface, the user types or selects one or more keywords, then queries the database of writing examples to find a match.

If the user knows the exact keywords that will retrieve the desired examples, then the keyword search may provide useful results. Often, however, the user does not know the exact keyword or combination of keywords that will produce the best examples. In addition, the user may also retrieve a large amount of extraneous data that contain the keyword(s). The user must then sift through all of the extraneous examples to find the desired examples. And as the number of writing examples in the writing examples database increases, this sifting process becomes quite time consuming.

What's more, different people will often choose different keywords to mean the same thing. One person will search for the word “company” while another will call the same object a “corporation.” Therefore, a keyword search for “company” would not necessarily retrieve writing examples with the word “corporation” in it, even though the user may wish to retrieve those examples.

Tree Interface—Another familiar desktop interface is the tree interface, often displayed using a file folder metaphor where the root folders contain a hierarchy of subfolders or documents. Microsoft Windows Explorer is an example of a tree interface.

The tree interface is structurally similar to an organic tree with various branches and sub-branches. The user navigates the hierarchy by selecting various branches and sub-branches till she reaches the desired examples.

The WriteExpress software (www.writeexpress.com) combines a tree and keyword interface to access its writing examples database.

Indexing is the chief drawback of a tree interface. For each group of writing examples being retrieved, the publisher must create a short phrase index or title that describes the theme of the writing examples.

This indexing of writing examples can be very confusing. It is easy for users get lost as they navigate through multi-level structures and try to understand the publisher's method of indexing. And the larger the database being accessed, the more time the user wastes finding writing examples. Thus the tree interface cannot effectively scale to access large writing example databases.

Map Interface—A map interface refers to any graphical interface where the user navigates via navigation links associated with locations on the computer screen.

In the retrieval of writing examples, a map interface is useful because keywords and classes of writing examples can be grouped in various areas of the screen. Likewise, the publisher can employ specific colors and shapes to help the user understand how the writing example database is organized for retrieval.

Another advantage of a map interface is that it makes it easier for the user to remember where keywords and objects are located on the interface. U.S. Pat. No. 6,421,066 to Sivan (1999) describes how a map interface can be further enhanced by overlaying the navigation links on a geographic map. Similarly, U.S. Pat. No. 6,160,551 to Naughton et al. (1995) proposes a real-life background where objects such as lamps, chairs, and tables in a living room are used to represent navigation links and software program controls.

The chief disadvantage of a map interface is that for large databases containing hundreds or thousands of writing examples, it's hard to fit the index information on the interface needed to access the database.

Dynamic Interface—U.S. Pat. No. 5,963,965 to Vogel (1999) reveals the inherent weakness of prior art text retrieval systems: there's a disconnect between the publisher and the user. The publisher has organized writing examples for retrieval using a certain structure, but the user must learn that structure. And the learning process can be a big time waster. In fact, anyone familiar with navigating the tree interface-structured “Help” screens of Microsoft Windows-based software knows how frustrating information access can sometime be.

Finding no easily understood text retrieval system available, Vogel's invention proceeds in an entirely new direction. Rather than create a hard-to-learn, “top down” classification structure for text retrieval, Vogel's invention proposes a dynamic interface that automatically indexes texts by extracting and processing the actual text contents, a kind of “bottom up” approach.

The virtue of this dynamic text retrieval method is that it indexes text “on the fly”. Unfortunately, to achieve indexing automation, the dynamic interface sacrifices retrieval precision and structure. Machine language capabilities are not sophisticated enough to precisely determine the meanings of texts. In today's world, a skilled human editor is a far more reliable classifier of writing examples.

Aiding the Writer's Thinking Process

No matter what prior art interface is chosen, writers often experience “writer's block”—an inability to start writing about a subject area To help the writer crystallize her thoughts and move from vague to concrete ideas, an ability to view sample subjects and sentence constructions would be very helpful. Sadly though, traditional text retrieval interfaces offer little assistance here.

Indeed, U.S. Pat. No. 5,660,548 to Ellenbogen (1996) shows how greeting cards can be designed with tear-off sheets of key words and themes to assist in the writing of personal correspondence. U.S. patent application 20020129069 of Sun (filed in 2001) proposes a computerized vocabulary reference tool to aid writing by displaying various words around a common theme.

While these writing aids are useful, their disadvantage is that they only deliver keywords related to a theme. They do not provide a system for retrieving writing examples or demonstrating good sentence construction.

Summary

Word processing and writing critique software are ubiquitous, but writing composition software has yet to achieve any significant commercial success, even though such software would fill an unmet need.

The main reasons for this deficiency are two:

1. The variety and breadth of human language has defied a simple method of classification. And any classification scheme or structure devised by a publisher requires the user to spend time learning that structure or “reverse engineering” the classification system.

2. The prior art interfaces—keyword, tree, map, and dynamic interface—are either inefficient or ineffective ways of accessing writing composition examples. They suffer from one or more defects, particularly: poor retrieval precision, complex indexing, or slow access speed.

### SUMMARY

The present invention is an aid to writing composition within a language domain. It begins with a process of classifying writing examples. It then provides a three-level interface for efficiently accessing those writing examples by selecting from among various noun and verb phrases.

Objects and Advantages

Accordingly, several objects and advantages of my invention are:

(a) to provide simpler, faster, and more precise access to writing examples within a language domain;

(b) to improve the quality and persuasive power of the user's writing;

(c) to offer the user ideas on themes and topics to write about within a domain;

(d) to educate the user about a domain and help her understand relationships between subjects in the domain;

(e) to provide access to strong or weak writing examples within a language domain;

(f) to provide an interface for foreign language speakers to access writing examples from another language;

(g) to eliminate the need to think about and type keywords to access writing examples;

(h) to eliminate the need to navigate through a complex, multi-level tree interface to access writing examples;

(i) to provide a writing examples retrieval that is simple enough for the user to readily understand the publisher's classification scheme.

(j) to provide an interface to writing examples that is memorable so that repeated use of the interface becomes more efficient;

(k) to expose examples of fine writing composition skills to users so they can become better writers by osmosis;

(l) to increase the confidence of the user and reduce her fear of writing;

(m) to guide users writing in fields such as the law, government, hazardous materials handling, and industrial equipment operation to the authorized or precise phraseology required in those fields.

(n) to enable publishers to create writing composition software that does not require advanced computing techniques such as natural language processing;

(o) to allow publishers to more easily market and sell a family of writing composition software across several niche language domains and language translation markets;

(p) to give publishers who own the copyright to a large corpus of writing within a domain a way to reuse that material in the sale of another product that their customers will find useful.

### DRAWING FIGURES

FIG. 1 is a process flow chart showing how the writing examples system is created.

FIG. 2 shows examples of root noun phrases and the nouns that are classified under those root noun phrases.

FIG. 3 shows examples of root verb phrases and the verbs that are classified under those root verb phrases.

FIG. 4 shows how the publisher extracts keywords and root noun and verb phrases from the original writing examples.

FIG. 5 illustrates how generic writing examples are derived from the original writing examples text.

FIG. 6 is the noun map where the root noun phrases of the domain are mapped and related to one another.

FIG. 7 is a verb map where the root verb phrases for a particular noun-to-noun relationship are displayed.

FIG. 8 is the results map where writing examples are displayed to the user.

### REFERENCE NUMERALS IN DRAWINGS

40 root noun phrase

42 common noun phrase selected

44 pronoun phrase

52 root verb phrase phrase

54 verbs that relate to root verb phrase

60 original text writing examples

62 keywords

64 root nouns and verbs examples

66 root noun phrase subject

68 root verb phrase

70 root noun phrase object selected to query

84 generic text writing example

86 subject keyword

88 verb keyword phrase in text

90 object keyword

100 noun category

102 relationship arrow in text

104 root noun phrase

106 first root noun phrase selected selected

108 second root noun phrase

120 subject root noun

122 object root noun phrase

124 subject-object arrow

126 root verb phrase

128 verb group category

130 number of writing

132 antonym highlighter

134 root verb phrase

136 pop down verbs to query

150 root verb phrase

152 subject root noun

154 verb in text

156 root noun phrase object

158 writing example

### DESCRIPTION

Preferred Embodiment

The aim of the preferred embodiment is make it easy for users composing a text to access and use fine writing examples from a particular writing domain.

Writing examples are most commonly sentences, but they may also be phrases or groups of sentences.

I will describe the preferred embodiment in two stages First, I will describe the process of classifying the writing examples; then, I will explain the structure of the user interface that access those writing examples.

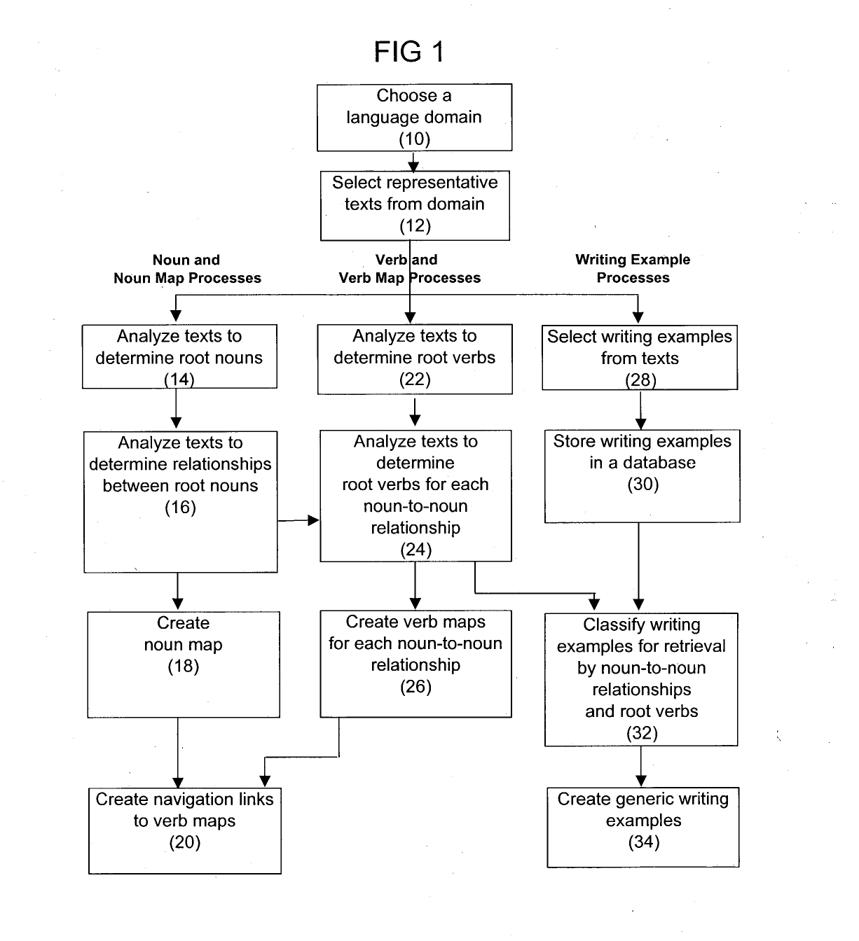

Process Flow—FIG. 1

FIG. 1 provides a flow chart of the preferred embodiment. The particular language domain selected to illustrate this embodiment is a business writing domain.

For purposes of our discussion, I will assume that a “publisher” is classifying the texts and creating the interface for a “user” to operate.

The first step is for the publisher to choose a suitable language domain 10. A good guide to writing domains is the way books are classified in a large bookstore. The shelves of these bookstores are devoted to categories such a cooking, romance novels, business, sports, travel, and so forth. To author books in each of these categories requires the writer to master a domain-specific vocabulary and often a unique writing style.

After selecting a writing domain, the next step is to select representative texts 12 such as magazine articles, newspaper stories, and books within the domain, making sure not to violate copyrights of those works.

Writing Examples Selection & Storage—FIG. 1

Selecting superior writing examples from the texts 28 is the next step.

The quality of writing-examples selected will generally be good if the corpus used is a popular magazine or other publication that is rigorously edited for quality. Nevertheless, an expert writer or editor will be a valuable resource in selecting the specific writing texts for the writing examples.

At this stage, the writing examples are simply selected and stored in a database 30. No attempt to classify the examples is taken at this time.

Selecting Root Noun and Root Verb Phrases—FIGS. 1, 2, 3

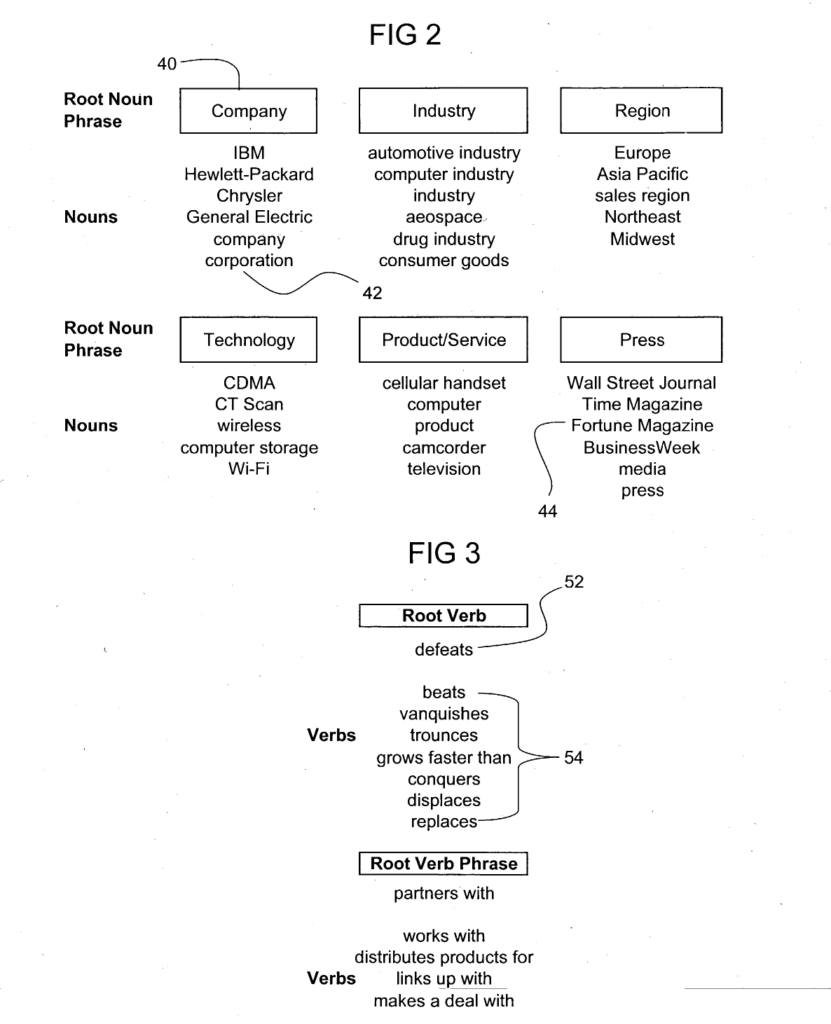

The next step is to analyze the original texts to create a category of root nouns or root noun phrases 14. Root noun phrases are common nouns that stand for other nouns in the texts. In FIG. 2, the root noun “Company” 40 is the generic equivalent of proper noun company names such as “IBM” and “Chrysler” as well as common nouns such as “company” and “corporation” 42. In another example, the proper noun “Fortune Magazine” 44 is categorized under the “Press” root noun phrase.

Computer processing greatly aids the root noun selection process. A computer program is written to count the frequency of individual words and phrases in the texts. Nouns or noun phrases that are frequently in use are then categorized into their root noun equivalents. Less frequently used nouns are ignored. Alternatively, the publisher may decide to add certain root nouns that are not frequently used.

The next step in the process (FIG. 1) is to analyze the domain texts to determine the root verb phrases 22.

The process of root verb classification is shown in FIG. 3. Here, the root verb “defeats” 52 stands for the generic equivalent of “beats”, “vanquishes”, “trounces”, and other verbs 54.

Once again, a high to low computer analysis of the frequency of words within the domain texts will help select root verbs.

Selecting Noun-to-Noun Relationships—FIG. 1

Now that the root nouns are identified and writing examples are chosen, the next step in the process (FIG. 1) is to analyze the texts to determine the relationships between root nouns 16.

The first step here is to take the writing examples stored in the database 30 and classify them according to the root noun phrases they contain.

Since we now know the particular root noun phrases used in the writing examples database, we can query that database for all instances of nouns and noun phrases that are related to our root noun phrases.

Examining the writing examples that contain a particular root noun phrase, we can now discover noun-to-noun relationships.

The type of relationships I refer to are subject-object or actor-actee relationships between one noun and another.

Looking at the writing examples that contain the root word “Company” as subject of the sentence, we may notice a strong preponderance of sentences where the root word “Technology” is the object of the sentence. And this makes sense because people in the business domain often write about a company's technology acquisitions and uses of technology to gain a competitive advantage.

So based on this information, we would identify “Company-Technology” as a subject-object relationship we want to capture in our classification scheme.

Typically there will be other root noun combinations where we find no relationships in the writing examples at all. For instance, perhaps we find no subject-object relationships between the root noun “Regulator” (as in government regulator) and the root noun “Distributor” (as in product distribution). So in this case, we will not use “Regulator-Distributor” as a subject-object relationship in our classification system.

As in the analysis of root nouns above, the frequency of use of a particular subject-object relationship is a helpful guide to determining the importance of that subject-object relationship in our classification system. The most frequently found relationships in the writing examples are generally the ones we will select for further analysis.

A subject-object relationship is not the only type of noun-to-noun relationship employed. For instance, a possessive relationship is more appropriate in some cases. An example here would be the root nouns “Company” and “Revenues” where the common relationship would be possessive, as in “Company's Revenues”.

Selecting Verbs for Subject-Objects—FIGS. 1, 4, 5

Having identified the noun-to-noun relationships we want to use in our classification system, our next task is to find the root verb phrases for each of these noun-to-noun relationships 24 (FIG. 1).

This can be accomplished by finding the most commonly occurring root verbs connecting the subject-object noun-to-noun relationships we just discussed.

Usually the root verb will be the “action” in a transitive sentence of the form: subject-verb-object or actor-action-actee.

In the case of the “Company-Technology” subject-object relationship, we might find verb phrases such as “exploits”, “invests in”, and “develops” within the writing examples.

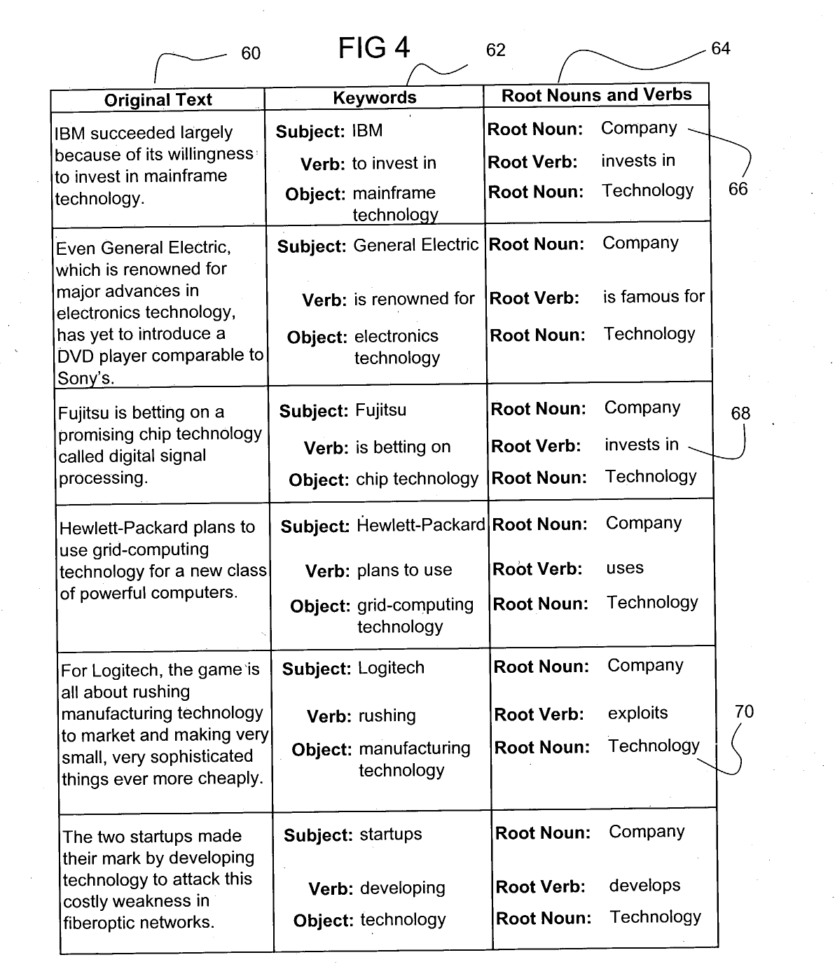

Classifying the Writing Examples—FIG. 4

FIG. 4 shows a sampling of original text writing examples 60 that would turn up if we queried our examples database for the “Company-Technology” relationship.

With these query results, we can now begin to classify the writing examples for later retrieval by the user.

The first step in the classification process is to scan the original text writing examples 60 to look for keyword subjects, verbs, and objects 62. The task here is not necessarily to select the one true grammatical subject, verb, and object of the sentence because in a compound sentence, there many be more than one of each. Instead, the subject, verb, and object should be selected to convey the overall meaning of the sentence for retrieval purposes.

The next step is to convert the keywords into root noun and verb phrases 64. Thus, we have selected the root noun “Company” 66 to signify the original subject noun “IBM” in the first example. Likewise, we have selected the root verb phrase “invests in” 68 for the original verb phrase “is betting on.” Finally, we selected the root noun “Technology” to categorize the original noun phrase object “manufacturing technology” 70.

So as you can see, we have now constructed a series of subject-verb-object combinations to use for classifying our writing examples for retrieval. From FIG. 4, these combinations are:

| Root Noun | Root Verb Phrase | Root Noun |
|---|---|---|
| Company | invests in | Technology |
| Company | is famous for | Technology |
| Company | invests in | Technology |
| Company | uses | Technology |
| Company | exploits | Technology |
| Company | develops | Technology |

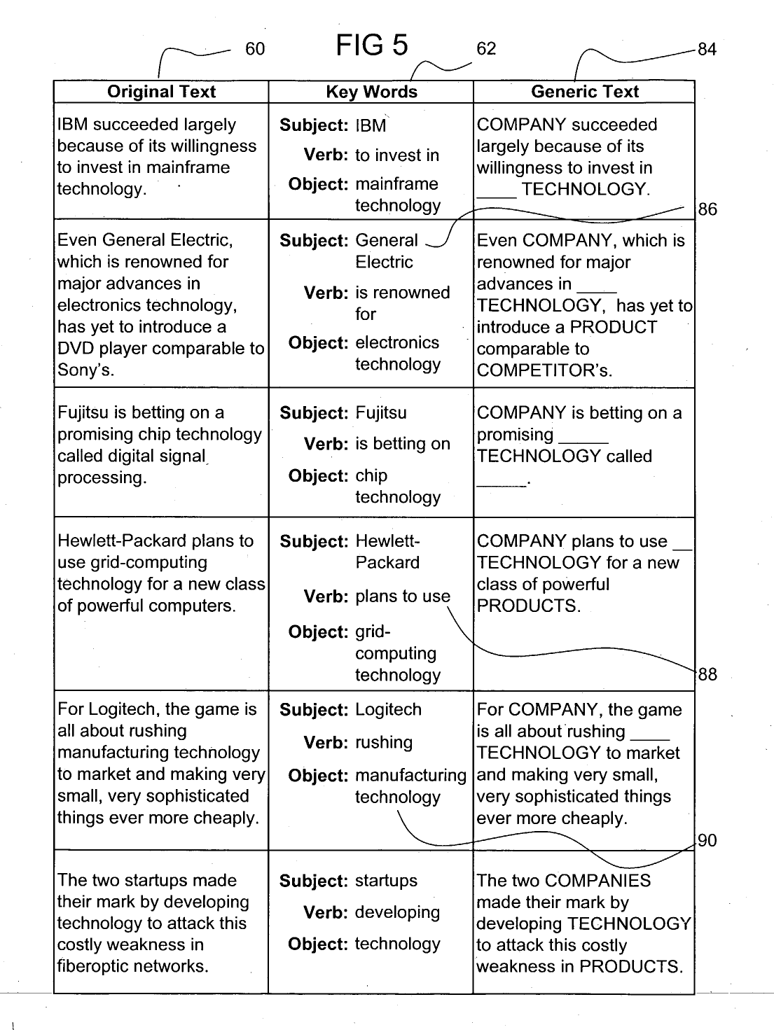

Creating Generic Writing Examples—FIGS. 1 and 5

Now that we have classified our writing examples by noun-to-noun relationships and root verb phrases 32 (FIG. 1), we are now ready to create generic writing examples from the original examples 34.

Referring to FIG. 5, we see the generic text writing examples 84 created from the original text 60 plus our knowledge of the root noun and verb phrases we will use to classify the writing examples.

For example we have substituted the root noun “COMPANY” for “General Electric” 86. We have decided to keep the verb phrase “plans to use” in the generic text 88 even though we have previously classified that verb phrase under the “uses” root verb. Finally, we have substituted the word “TECHNOLOGY” for the object noun phrase “manufacturing technology” 90.

We will use these generic text writing examples as the text to display to the user after a query is made.

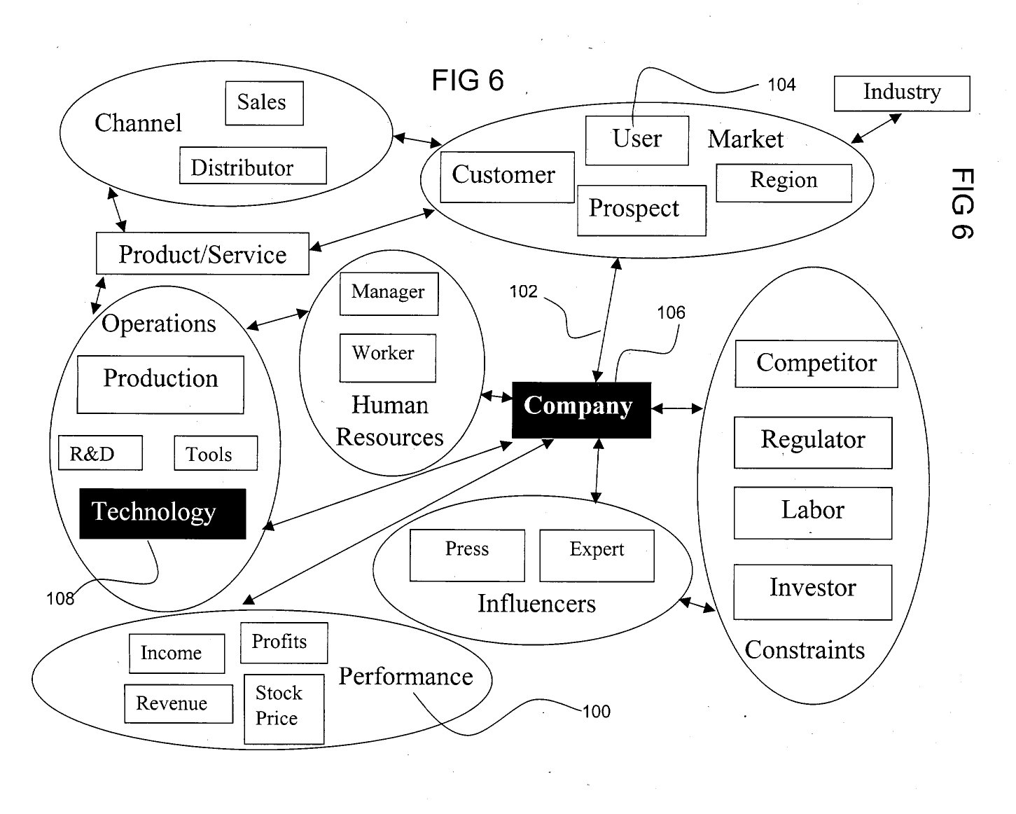

The Noun Map—FIGS. 1 and 6

The next task is to create the noun map 18 (FIG. 1).

The noun map is shown in FIG. 6. It comprises root noun phrases arranged in a way that's easiest for the user to understand the relationships between the root noun phrases. In general, the more the map can show the flow of the language domain, the easier it will be for the user to operate it.

Clusters of root noun phrases are grouped in a graphically disparate region 100 to aid map comprehension and memory. Arrowed lines 102 are also drawn to illustrate the relationships between these clusters or specific root noun phrases.

The actual root noun phrases 104 are enclosed in a graphic box or are left to float free on the map. Graphic enhancement via colors or highlighting are used to signify selections of particular root noun phrases on the map.

We have used a white font on a black background to illustrate the two root noun phrases to be selected by the user, “Company” 106 and “Technology” 108. The first root noun phrase select becomes the subject and the second phrase selected becomes the object in a subject-object relationship.

The number of root nouns to place on the noun map is a function of map usability. If too many root nouns are selected, the noun map may become too crowded. On the other hand, with a greater number of root nouns used, the user can access the writing examples with great precision. Publishers will choose a happy medium between these extremes. Another way to fit more rout nouns on the map is to equip the map with a foveal capability that magnifies portions of the map as the mouse goes over those sections, working much like a magnifying glass.

The key to designing the noun map is a matter of grouping nouns and using arrows to show the process flow of the domain or the relationships between the nouns.

The most commonly used root noun phrases in the domain language occupy the center of the map. Less commonly used root noun phrases are placed at the edges of the map.

To add human interest to the map, the background of the map contains a language domain-specific photograph or illustration (not shown).

In some cases, icons and illustrations (not shown) are also used instead of the root noun phrases. For instance, “Company” could be represented as an office building. Likewise, “Technology” could be represented as an atom with electrons rotating around it.

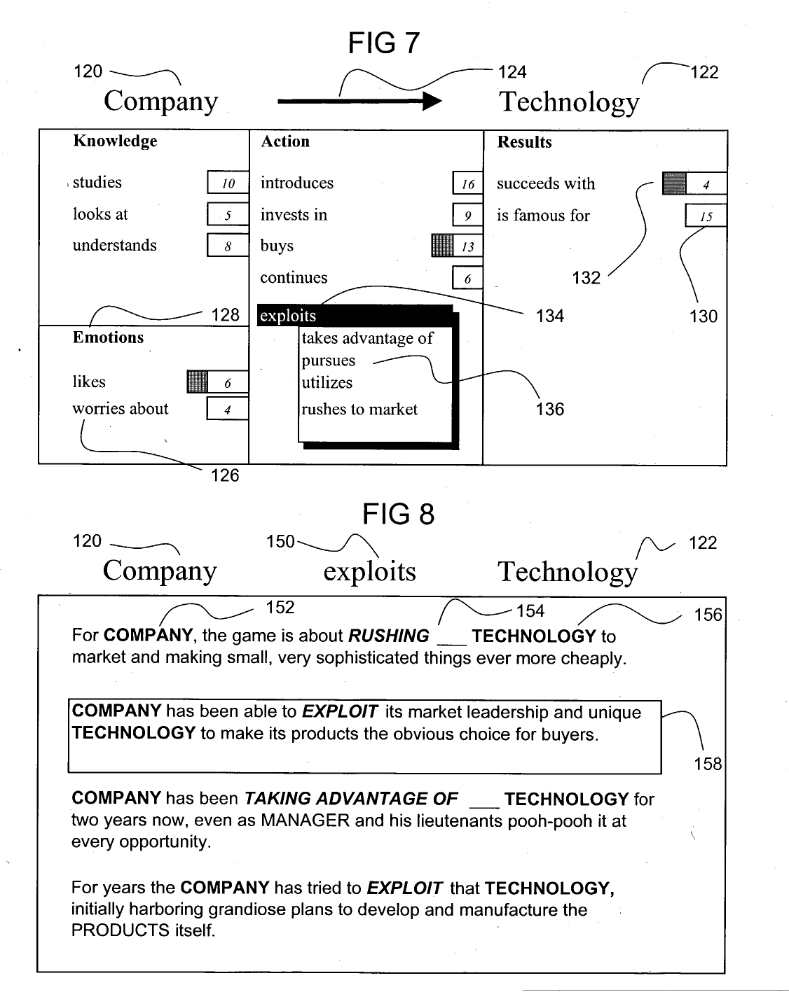

The Verb Maps—FIGS. 1 and 7

The second type of user map to be created is the verb map for each noun-to-noun relationship 26 (FIG. 1).

A sample verb map for the noun-to-noun relationship “Company-Technology” is shown in FIG. 7. The map includes the root noun subject “Company” 120 and the root noun object “Technology” 122. A subject-object arrow 124 points from the subject to the subject noun. The subject-object arrow also includes a reversal mechanism so that the arrow can be point in the opposite direction to indicate that the subject has changed to the object and vice versa.

The actual root verb phrases such as “worries about” 126 are grouped in certain verb category regions 128 with titles such as “Emotions”, “Knowledge”, “Action”, and “Results.” By placing the root verbs in these regions, it becomes easier for the user to remember where certain types of verbs are placed on the map.

Among the other features of the verb map are a display of the number of writing examples in the database that correspond to the particular subject-verb-object 130. In addition, a highlighted area next to certain root verb phrases is an indicator for the root verb's antonym (or opposite meaning) 132.

A facility is also within the map to pop-up a series of specific verbs 136 that are categorized under a particular root verb phrase 134.

In this preferred embodiment, verb maps are either individually designed, or a series of verb map templates is employed for certain types of noun-to-noun relationships. Each of those templates has common regions for verbs to categorized. In this way, the particular root verb phrases for a particular noun-to-noun relationship can be dynamically loaded into the map.

To effect this template capability, root verb phrases for a particular noun-to-noun relationship must be classified by these regional categories.

The Results Map—FIGS. 5 and 8

The final user map in the interface is the results map (FIG. 8) which is created dynamically based on the query results.

At the top are the subject root noun phrase 120, object root noun phrase 122, and root verb phrase 150 previously selected in the verb map.

The four writing examples shown in FIG. 8 are individual sentences, but a writing example could also be a series of sentences or a short phrase.

The writing examples shown will not be the original text but the generic text writing examples shown in 84 of FIG. 5.

The root subject noon 152 (FIG. 8), verb 154, and root object noun 156 will typically be highlighted or colored to make it easier for the user to see where he may need to substitute his own word or access an electronic thesaurus for synonyms (not shown).

The results map will have enough display space to show several writing examples at one time. Additional examples can be viewed by scrolling down on the map (not shown).

When the user finds a particular writing example that he would like to insert into his document, the map will allow the user to copy the writing example 158 in an electronic clipboard for insertion within a word processing document (not shown).

Alternative Embodiments

There are various possibilities related to the content of the writing composition system.

For instance, the preferred embodiment is designed to illustrate good writing examples. Such a system could also be used to illustrate bad writing examples, as a teaching aid, for example.

Another embodiment is as a language translator. For instance, the words shown in the noun map (FIG. 6) and verb map (FIG. 7) could be written in a foreign language. In that way, a Spanish speaker could access the database in his own language and be presented with English writing examples in the results map (FIG. 8). In this case, the English writing examples would be accompanied by a Spanish translation in the results map.

Our preferred embodiment implies a computer interface, but the interface could also be built into a handheld device, such as a cellular phone or small language translator.

Advantages

From the description above, a number of advantages of my invention are apparent:

The classification process greatly simplifies software creation for the publisher. The human interface requires no advanced computational techniques or natural language processing capabilities. And with the money saved building the interface, the publisher now has the resources to invest in improving the software's content.

The simplicity of the interface is especially attractive to the non-professional writer. For example, unemployed people are often frustrated by the process of writing their job resumes. Indeed, composing a polished resume is a big challenge for the occasional writer. But this is an ideal domain to build a writing examples system around, one that provides easy assess to the best writing examples from professionally written resumes.

Because the noun maps and verb maps is composed of short, easily-understood root noun and verb phrases, users can quickly drill down to the writing examples they need. In fact, the user simply follows the same classification “trail” the publisher used to index the writing examples in the first place. Little translation effort is required by the user to understand the publisher's indexing scheme. By contrast, in a tree interface, each writing example is indexed by a paraphrased version of the writing example so users need to perform an additional index translation process in the brain.

Operation

In the preferred embodiment, the user is working at a computer. To illustrate, let's say the user works for an aerospace company and is tasked with writing a report on business developments in the aerospace industry.

As the user is composing the report in his word processor program, he desires a more powerful way to write about how his company is exploiting technology. So he clicks a link or presses a function key in his word processor program (not shown) to access the noun map (FIG. 6) to a writing examples database for the business domain.

Scanning the noun interface, the user knows that he wants to use his company as subject of the sentence, so he clicks on the word, “Company” 106 which causes the interface to be highlighted or changed to a new color.

The next step is to select the grammatical object of the particular writing theme he has in his mind. So in this case he clicks the word “Technology” 108.

Having selected a second root noun, the navigation link in the noun map now takes the user directly to the “Company-Technology” verb map (FIG. 7). Here the user is presented with a number of verb root phrases to choose from. The user scans the map to find the particular root verb that seems closest to the meaning he has in mind. The map shows him how many writing examples exist for each subject-verb-object choice 130. He can also select the antonym of a particular root verb 132.

In this case, the user selects the verb “exploits” 134 at which point a navigation link takes him directly to the results map (FIG. 8).

In the results map, the user is presented with a choice of several writing examples that match the meaning of “Company exploits Technology”.

When the user finds a suitable writing example, he selects the writing example 158 and it is copied to memory or directly inserted into the word processing document (not shown).

Conclusion, Ramifications, and Scope of Invention

Accordingly, the reader will see that my method of classifying and accessing writing composition examples can bring the power of excellent writing to non-professional and professional writers alike:

As our operating description shows, the writing example system provides precise and speedy access to the underlying corpus of writing examples. In fact, with as few as four mouse clicks the user can be reading and selecting from writing examples written by professionals.

With an intuitive interface such as this, users no longer need to be intimidated by writing. As long as users have a vague idea of the subjects they want to write about, the interface will guide them to appropriate examples.

Users also no longer need to search their brain for keywords or face the steep learning curve and cumbersome navigation of a tree interface and its indexes.

The simplicity of this classification methodology and interface will also attract publishers, specifically:

It permits publishers to create a family of writing composition software based on a template that the publisher modifies slightly for individual language domains. The publisher no longer has to devise a complex tree interface or index for each language domain. Publishers can also spread their software development costs across multiple writing composition products.

Marketing and advertising expenses will also be lower since the user can be encouraged to buy individual language domain modules from a family of software that works in a consistent and familiar manner.

Publishers can likewise develop an on-demand market for their writing composition software. Users can be encouraged to buy modules for the specific task at hand. If a student needs to write an essay on American history, he can buy an American history module. If a business person is visiting Japan, a handheld electronic translator that embodies the classifying scheme and interface can be sold for translating English sentences into Japanese.

Although the description above contains many specificities, these should not be construed as limiting the scope of the invention but as merely providing illustrations of embodiments of this invention. For instance, we have structured the three maps of the interface as three separate screens of information, but another embodiment could merge the three maps onto one screen.

Thus the scope of the invention should be determined by the appended claims and their legal equivalents, rather than by the examples above.

I claim:

1. A method for classifying and retrieving a plurality of writing examples providing:
(a) means to select root noun phrases and root verb phrases from a text domain;
(b) means to select relationships between said root noun phrases;
(c) means to classify writing examples for retrieval by said noun phrases, said verb phrases, and said relationships between said root noun phrases;
(d) a memory which is able to store said writing examples and the classifications of said writing examples in a database;
(e) an interface comprising: a noun map having a substrate layer and displaying a plurality of said root noun phrases; a plurality of verb maps displaying a plurality of said root verb phrases; and a results map displaying a plurality of said writing examples;
(f) a display which is operatively connected to said memory for displaying objects in said interface;
(g) a pointer means to select navigation links on said objects in said interface;
(h) means to select pre-determined relationships between a plurality of said root noun phrases on said noun map;
(i) means to navigate to one of said verb maps based on the selection of one said pre-determined relationship in said noun map using said pointer means;
(j) means to select one said root verb phrase in said verb map;
(k) means to navigate to said results map based on the selection of said root verb phrase in said verb map and selection of one said relationship in said noun map.
(l) means to retrieve a plurality of said writing examples from said database for display in said results map.
(m) means to copy a plurality of said writing examples in said results map into said memory for later insertion in a word processing document.

2. The method of claim 1 wherein graphic symbols are substituted for said root noun phrases in said noun map.

3. The method of claim 1 wherein said root noun phrases and said root verb phrases are in a different language from said writing examples retrieved.

4. The method of claim 1 wherein said root nouns and root verbs are substituted with other words in said writing examples.

5. The method of claim 1 wherein a graphical theme is displayed in said substrate of said noun map.

6. The method of claim 1 wherein said interface is used to retrieve said writing examples from the Internet.

7. The method of claim 1 wherein said interface is used to retrieve said writing examples from a portable electronic apparatus.

8. The method of claim 1 wherein said root nouns on said noun map are clustered into regions based on relationships between said root nouns.

9. The method of claim 1 wherein said root verb phrases in said verb map are clustered into regions based on relationships between said root verb phrases.

10. The method of claim 1 wherein one said root verb phrase in said verb map is selected to display a plurality of verb phrase choices categorized under one said root verb phrase.

11. The method of claim 1 wherein individual words or phrases in said writing examples in said results map are programmatically linked to an electronic thesaurus.

12. The method of claim 1 wherein one said root noun phrase in said noun map is selected and said navigation link takes user to said verb map.

13. The method of claim 1 wherein an object adjacent to said root verb phrase in said verb map is selected to substitute said root verb phrase with an antonym verb phrase of said root verb phrase.

14. The method of claim 1 wherein an object adjacent to said root verb phrase in said verb map is selected to substitute said root verb phrase with a negative verb phrase of said root verb phrase.

15. The method of claim 1 wherein the user is taken to one said verb map after typing two said root noun phrases in said interface.

16. The method of claim 1 wherein the user is taken to one said results map after typing two said root noun phrases and one said root verb phrase in said interface.

17. The method of claim 1 wherein said verb maps are embodied in a plurality of templates wherein said root verb phrases are dynamically loaded into said templates.
